(19) United States
(12) Patent Application Publication
(10) Pub. No.: US 2013/0249893 A1
(43) Pub. Date: Sep. 26, 2013

(54) Virtual aligner

(71) Applicant: Tarun Mehra, Calgary (CA)

(72) Inventor: Tarun Mehra, Calgary (CA)

(73) Assignee: Tarun Mehra, Calgary (CA)

(21) Appl. No.: 13/424,478

(22) Filed: Mar. 20, 2012

(51) Int. Cl. G06T 17/00; G06T 3/60; G09G 5/32

(52) U.S. Cl. 345/419; 345/672; 345/664

(57) ABSTRACT

The virtual aligner is used to re-align the two virtual components of a three dimensional digital model, such as virtual dental or orthodontic arches. An infinite number of new alignments can be created and saved by the user without altering the original record.

The virtual aligner allows the user to move the mandibular virtual arch in relation to a static maxillary virtual arch. Translational movement of the virtual mandible is along each of the x, y, or z axes, left and right, up and down, and back and forth, respectively. Rotational movement of the virtual mandible is around each of the x, y or z axes.

### BACKGROUND OF THE INVENTION

In all references, “three dimensional virtual aligner” is the same as “virtual aligner” and “digital aligner”, and “digital models” and “digitized models” are considered the same as a “virtual models” or “computer generated models”, all of which are topographical three dimensional representations for the purposes of this invention.

The illustrations and drawings attached to this document form an integral part of the submission and should be used in conjunction with the text, as referenced, to aid in a full understanding of the invention.

In the dental and orthodontic industry, there is a growing reliance on digital records for patient care. Clinicians are using digitized models in place of the traditional plaster or stone models because of the versatility and ease of use, as well as the need to save space, time and money on maintaining a complete set of medical and dental records for each patient.

Dental or orthodontic models are generally comprised of two parts, the mandibular and maxillary dental arches. For the purpose of this submission, three dimensional digital models are virtual representations of a patient's teeth and gingival, and are used as a record for a patient's dental health, tooth and arch alignment.

There are several methods of creating these digitized records. Clinicians may use an intraoral scanner that creates a digitized record of the topographical surfaces each of the dental arches. Alternatively, the clinician takes a negative impression of each dental arch using a hydrocolloid or rubber based material. Scans can be taken directly from the impressions to create three dimensional digital models. Plaster or stone models can be created from the negative impressions, which are then scanned to create the digital version of the mandible and maxilla.

The clinician also makes an occlusal registration which indicates the patient's dental arch alignment. Clinicians use the occluded digitized models as an integral part of the diagnostic and treatment planning process. Current programs produce a virtual model in which the two arches are aligned in one static position.

It is common for errors to be made in the alignment of the three dimensional virtual arches in a static position. The resulting digital images do not accurately portray the patient's actual dental alignment. An occlusal registration may be inaccurate for several reasons. Often, when the patient is biting into a malleable occlusal registration material or is required to hold the jaw position while a material is inserted around the patient's teeth, the patient may articulate the mandible into an unnatural position and create an inaccurate record.

A virtual aligner for dental models will allow the clinician to view the patient's three dimensional virtual or digital models and adjust the occlusal alignment between the two dental arches.

### SUMMARY OF THE INVENTION

The invention is a three dimensional virtual aligner used for but not limited to diagnosing and treatment planning for dental and medical specialties, including but not limited to orthodontics, prosthodontics, endodontics, periodontics, oral medicine, orthognathic surgery, implant positioning, crown and bridge and prosthesis design.

The invention is designed for use with any computer-generated, processed three dimensional digital representations of a patient's maxillary and mandibular anatomy. Files in, but not limited to, three dimensional closed-surface STL or stereo lithographic data format, can be processed for use with this invention.

The virtual aligner allows the clinician to realign the two virtual components of three dimensional digital models so that they more accurately represent the actual occlusion of the patient's arches. For the purposes of this submission, digital dental or orthodontic models are used to demonstrate the utility of this invention but the uses are not limited to the fields of dentistry and orthodontics.

Using the virtual aligner, the clinician is able to realign the virtual dental arches when there is an error in the original alignment of the virtual models. The realigned digital representations can also be used to demonstrate the results of changes in arch alignment. An infinite number of new alignments can be created and saved using the virtual aligner without altering the original record.

The virtual aligner allows the user to move lower or mandibular virtual arch, while the upper or maxillary virtual arch remains stationary. Translational movement of the virtual mandible is along each of the x, y, or z axes, left and right, up and down, and back and forth, respectively. Rotational movement of the virtual mandible is around each of the x, y or z axes.

### BRIEF DESCRIPTION OF THE DIAGRAMS

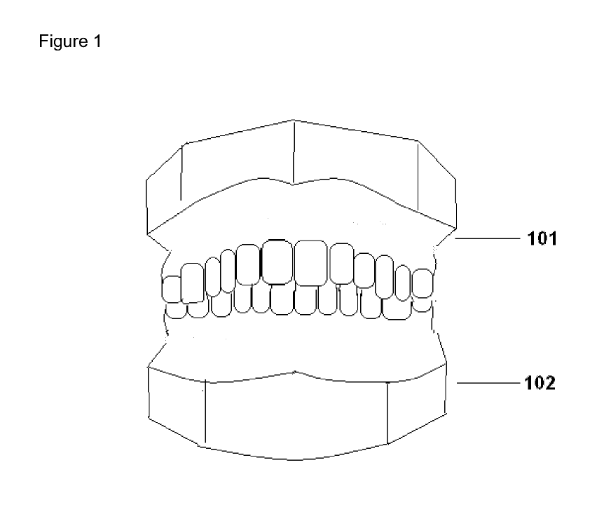

FIG. 1 Default alignment of three dimensional digital models, front view

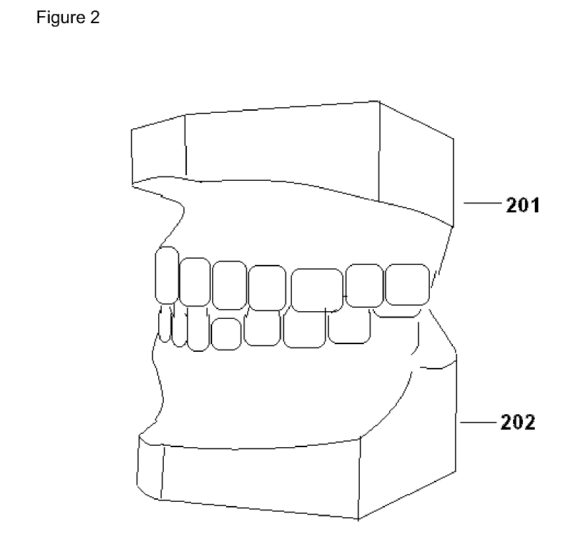

FIG. 2 Default alignment of three dimensional digital models, side view

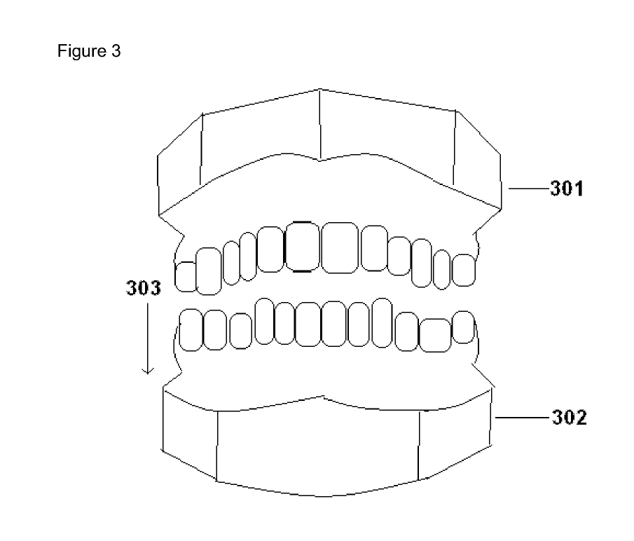

FIG. 3 Arch position due to translational movement open along the Y axis

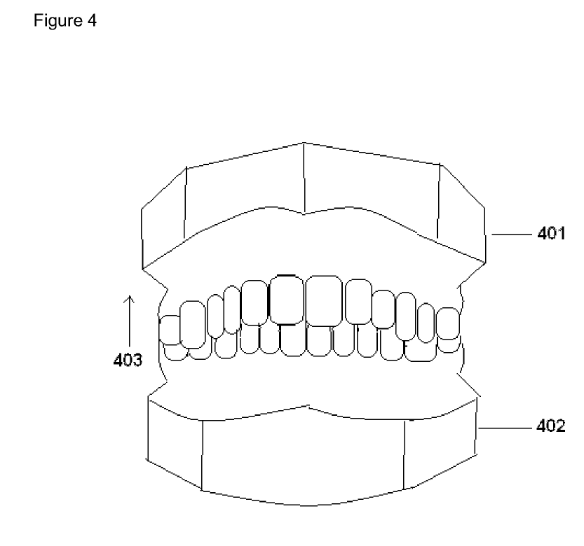

FIG. 4 Arch position due to translational movement closed along the Y axis with tooth intersects

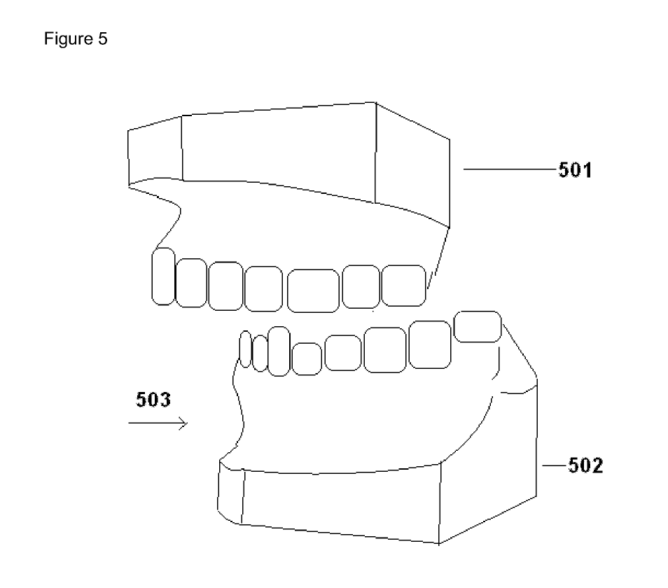

FIG. 5 Arch position due to translational movement back along the Z axis

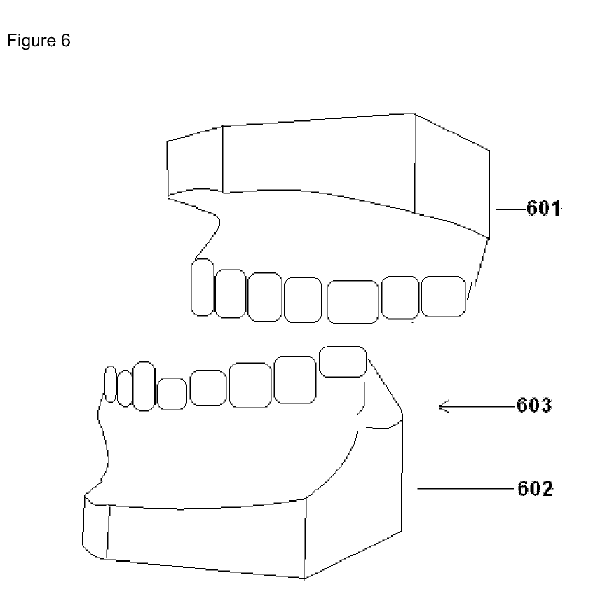

FIG. 6 Arch position due to translational movement forward along the Z axis

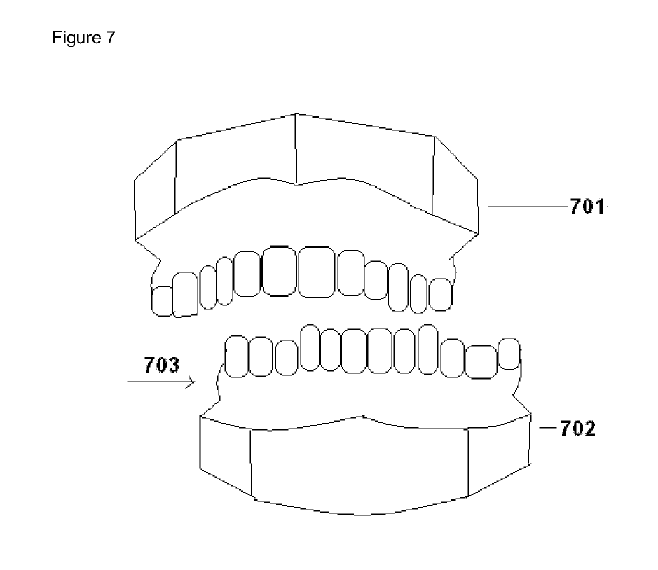

FIG. 7 Arch position due to translational movement to the left along the X axis

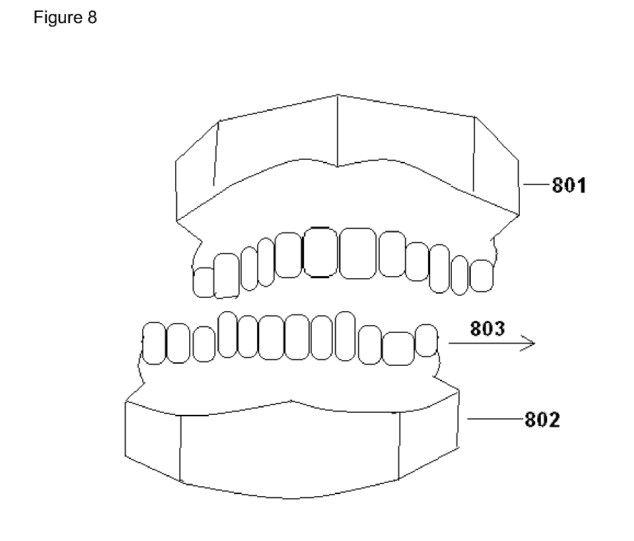

FIG. 8 Arch position due to translational movement to the right along the X axis

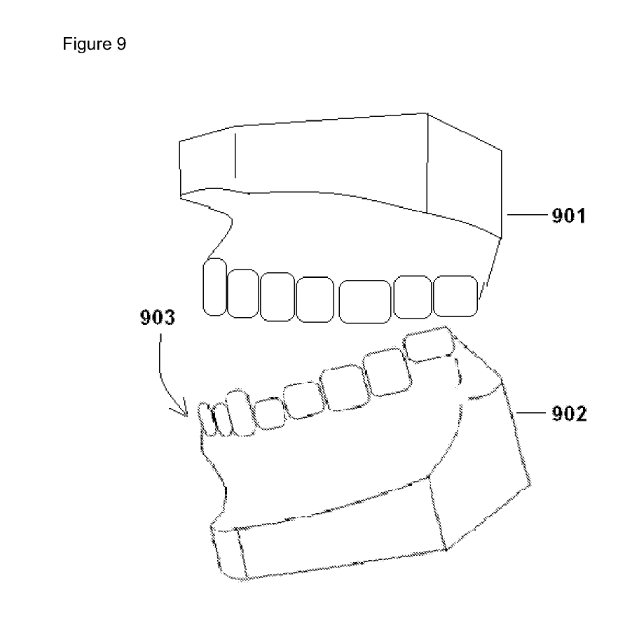

FIG. 9 Arch position due to rotational movement on the X axis, anterior movement

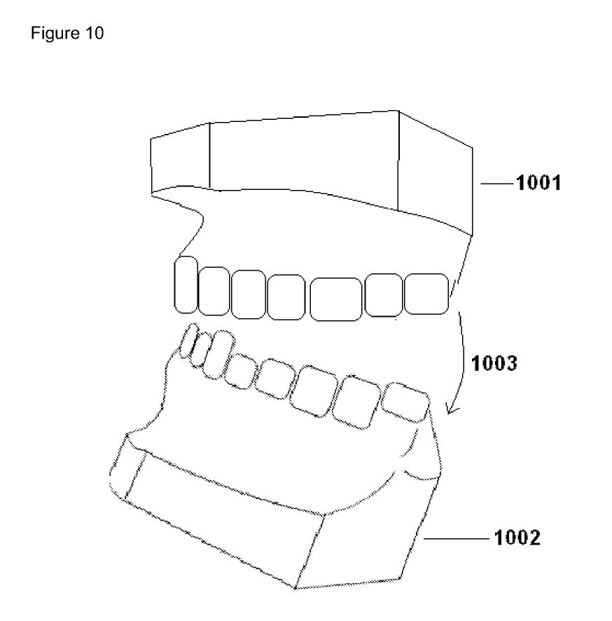

FIG. 10 Arch position due to rotational movement on the X axis, posterior movement

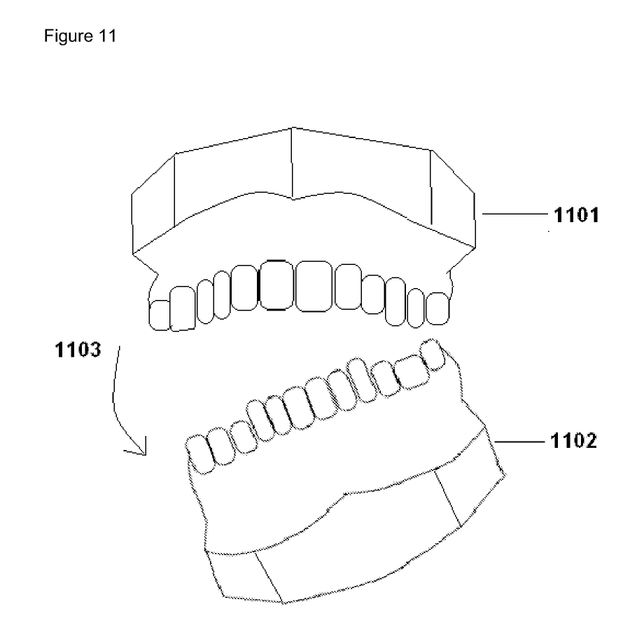

FIG. 11 Arch position due to rotational movement around the Z axis, right side open, left side closing

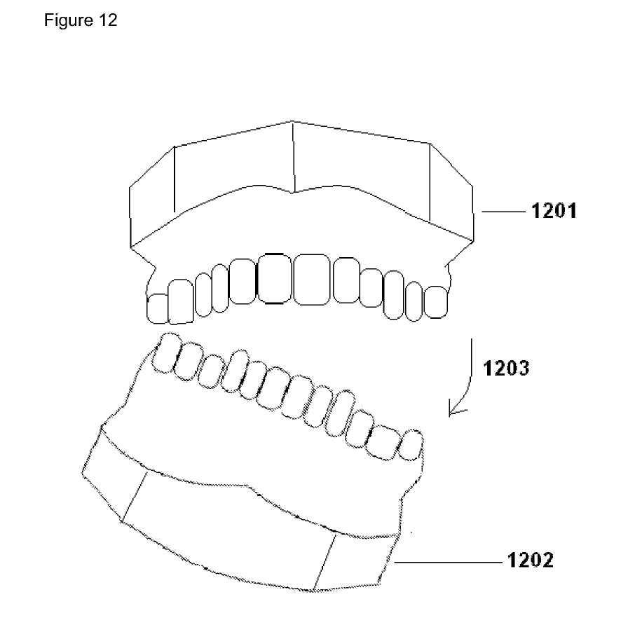

FIG. 12 Arch position due to rotational movement around the Z axis, left side open, right side closing

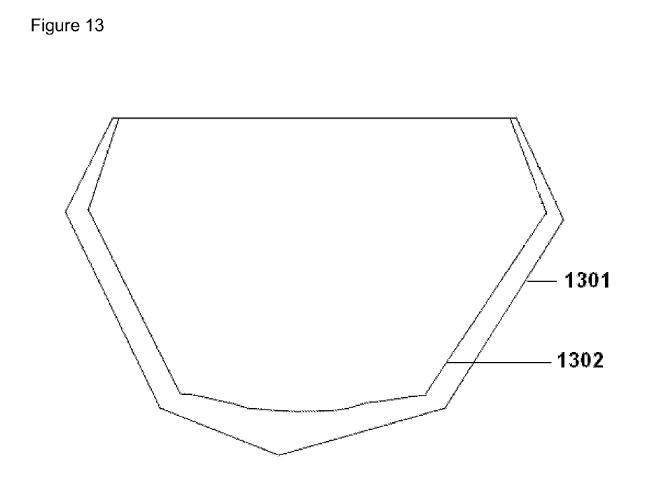

FIG. 13 Default view of three dimensional digital models from the top, illustrating alignment prior to adjustment

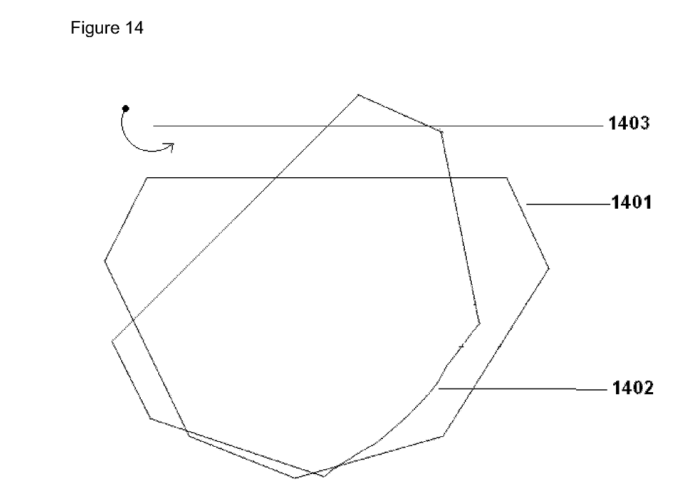

FIG. 14 View of three dimensional digital models from the top, illustrating alignment with rotational movement to the right

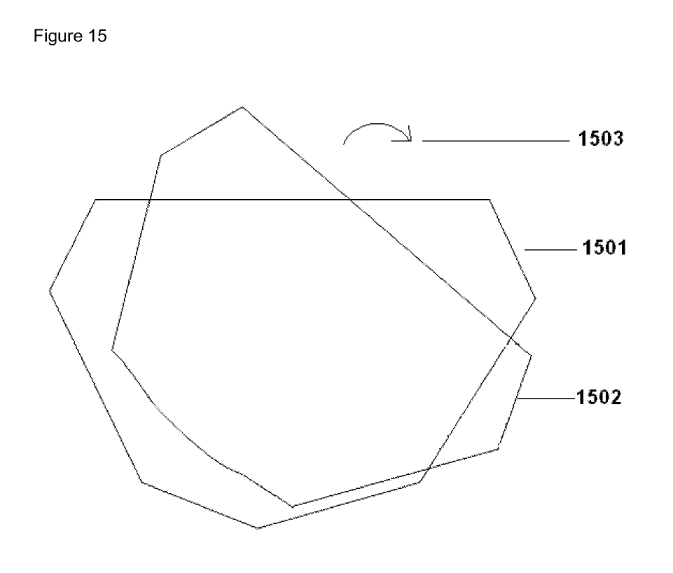

FIG. 15 View of three dimensional digital models from the top, illustrating alignment with rotational movement to the left

### DETAILS OF THE INVENTION

For the purposes of this submission, this document will focus on digital dental/orthodontic models, but the uses of the virtual aligner are not limited to digital dental/orthodontic models.

Prior to using the virtual aligner, it is necessary to have three dimensional digital models. Plaster or stone maxillary and mandibular dental arches can be created from impressions provided by the clinician and aligned using an occlusal registration. Either the impressions or the plaster/stone models are scanned to create a digital representation of the models. Alternatively, the client may provide a closed-surface stereo lithographic file (STL) format of a model, but not limited to this file format, for use with the virtual aligner.

The virtual aligner allows the clinician to align the virtual arches of the three dimensional digital model so that the occlusion more closely represents a patient's actual occlusion. Realignment of the virtual arches is accomplished by adjusting the position of the virtual mandibular arch in relation to the static virtual maxillary arch.

The virtual maxillary and mandibular arches of the three dimensional virtual models are aligned according to an occlusal registration provided by the clinician. FIG. 1 illustrates the occluded virtual dental arches when seen from the front, while FIG. 2 is a side-view of the same three dimensional digital models.

Re-alignment of the virtual mandibular arch in relation to the virtual maxilla is enacted by using onscreen controls. Movement of the virtual mandibular arch can be either translational or rotational. Translational movement is the movement of the virtual mandibular arch up and down along the y axis (FIGS. 3 and 4), back and forth on the z axis (FIGS. 5 and 6) or left and right along the x axis (FIGS. 7 and 8).

Rotational movement of the virtual mandibular arch around the X axis is illustrated in FIGS. 9 and 10, while rotation around the Z axis is illustrated in FIGS. 11 and 12.

FIG. 13 illustrates the alignment of the virtual maxilla and virtual mandible as viewed from the top, where the posterior edges of the models are aligned. This positioning of the virtual arches is determined by the occlusal registration provided by the clinician and represents the starting point before rotational movement of the virtual mandible. Rotation around the Y axis is illustrated in FIGS. 14 and 15.

These movements, as described, are used to adjust the position of the virtual mandible in relation to the virtual maxilla so that the operator can more accurately align the occlusion of the virtual arches for demonstration or corrective purposes.

These and the various other attributes, features and uses of the invention which are unique and novel are noted with clarity in the claims annexed to this document and form part hereof. For a better understanding of the invention, the reader should refer to the diagrams which are attached and also form part hereof this submission.

This invention has been described in detail in this document with the embodiments thereof with reference to accompanying illustrations and drawings that are use to clarify the concepts pertinent to the invention. The embodiment and the claims of this invention were described in the context of dentistry, prosthodontics, endodontics, periodontics, orthodontics and oral surgery. However, there are several combinations and alterations to the designs that can be made to change the use of this invention that can be applied to but not limited to other fields such as medicine, three dimensional cad/cam designs, milling, manufacturing, and aeronautics, which use the specifications that are herein described for this invention. It will be understood that the embodiments are representative and that a variety of modifications, substitutions and alterations are possible without departing from the spirit and scope of the present invention for those who are skilled in the art and field, and who can conceive these changes to the embodiments and applications in different sectors. This invention can be utilized as a process, an embodiment of a system, or a computer generated diagnostic tool. It is understood that variation of uses of this invention includes uses in fields that are not described in this disclosure to which the invention pertains and may be applied herein set forth and follows the scope of the claims.

### DETAILED DESCRIPTION OF THE DIAGRAMS

FIG. 1 Default alignment of three dimensional digital models, front view. This diagram is of the virtual maxilla (101) and the virtual mandible (102) occluded or aligned in the position indicated by the bite registration provided by the clinician as viewed from the front.

FIG. 2 Default alignment of three dimensional digital models, side view. This diagram is of the virtual maxilla (201) and the virtual mandible (202) occluded or aligned in the position indicated by the bite registration provided by the clinician as viewed from the side.

FIG. 3 Arch position due to translational movement open along the Y axis. This diagram illustrates the result of translational movement of the virtual mandible (302) along the Y axis in the direction indicated by 303 while holding the virtual maxilla (301) stationary, expanding the distance between the virtual arches.

FIG. 4 Arch position due to translational movement closed along the Y axis with tooth intersects. This diagram illustrates the result of translational movement of the virtual mandible (402) along the Y axis in the direction indicated by 403 while holding the virtual maxilla (401) stationary.

FIG. 5 Arch position due to translational movement back along the Z axis. This diagram illustrates the position of the virtual maxilla (501) in relation to the virtual mandible after moving the virtual mandible (502) in the direction indicated by 503.

FIG. 6 Arch position due to translational movement forward along the Z axis. This diagram illustrates the position of the virtual maxilla (601) in relation to the virtual mandible (602) after moving the virtual mandible (602) in the direction as indicated by 603.

FIG. 7 Arch position due to translational movement to the left along the X axis. This diagram illustrates the position of the virtual maxilla (701) in relation to the virtual mandible (702) after moving the virtual mandible (702) in the direction as indicated by 703.

FIG. 8 Arch position due to translational movement to the right along the X axis. This diagram illustrates the position of the virtual maxilla (801) in relation to the virtual mandible (802) after moving the virtual mandible (802) in the direction as indicated by 803

FIG. 9 Arch position due to rotational movement on the X axis, anterior movement. This diagram illustrates the position of the virtual maxilla (901) in relation to the virtual mandible (902) after rotating the virtual mandible (902) in the direction as indicated by 903.

FIG. 10 Arch position due to rotational movement on the X axis, posterior movement. This diagram illustrates the position of the virtual maxilla (1001) in relation to the virtual mandible (1002) after rotating the virtual mandible (1002) in the direction as indicated by 1003.

FIG. 11 Arch position due to rotational movement around the Z axis, right side open, left side closing. This diagram illustrates the position of the virtual maxilla (1101) in relation to the virtual mandible (1102) after rotating the virtual mandible (1102) in the direction as indicated by 1103.

FIG. 12 Arch position due to rotational movement around the Z axis, left side open, right side closing. This diagram illustrates the position of the virtual maxilla (1201) in relation to the virtual mandible (1202) after rotating the virtual mandible (1202) in the direction as indicated by 1203.

FIG. 13 Default view of three dimensional digital models from the top, illustrating alignment. This diagram illustrates the position of the virtual maxilla (1301) in relation to the virtual mandible (1302) and the virtual mandible (1302) in the closed position.

FIG. 14 View of three dimensional digital models from the top after rotational movement to the right. This diagram illustrates the position of the virtual maxilla (1401) in relation to the virtual mandible (1402) after rotating the virtual mandible (1402) in the direction indicated by 1403.

FIG. 15 View of three dimensional digital models from the top, illustrating alignment after rotational movement to the left. This diagram illustrates the position of the virtual maxilla (1501) in relation to the virtual mandible (1502) after rotating the virtual mandible (1502) in the direction as indicated by 1503.

1. A method to adjust the alignment of a set of virtual models by moving the virtual mandible in relation to the virtual maxilla.

2. Further to claim 1, movement of the virtual mandible may be either translational or rotational in any direction or combination of directions on or around the x, y and z axes.

3. Further to claim 1, after each adjustment to the alignment has been completed, the operator can rotate in the occluded virtual models 360 degrees in each of and in any combination of directions within the x, y and z axes.

4. Further to claim 1, after each adjustment to the realignment, the operator can cause the virtual image of the three dimensional three dimensional digital model to increase or decrease in size, and this can be done in any configuration or angle the operator is viewing in the virtual aligner.

5. Further to claims 1 and 2, an infinite number of new alignments can be created and saved by the user without altering the original record.
